(19) United States
(12) Patent Application Publication
(10) Pub. No.: US 2021/0301123 A1
(43) Pub. Date: Sep. 30, 2021

(54) EXTRUSION PROFILE FOR A DOOR COMPONENT AND/OR WINDOW COMPONENT AS WELL AS A MANUFACTURING METHOD

(71) Applicant: Salamander Industrie-Produkte GmbH, Tuerkheim (DE)

(72) Inventor: Till Schmiedeknecht, Muenchen (DE)

(73) Assignee: Salamander Industrie-Produkte GmbH, Tuerkheim (DE)

(21) Appl. No.: 17/214,268

(22) Filed: Mar. 26, 2021

(30) Foreign Application Priority Data
Mar. 27, 2020 (DE) 102020108569.9

(51) Int. Cl. C08L 67/00; E06B 3/22; C08L 27/06; B29C 48/12

(52) U.S. Cl. CPC C08L 67/00; E06B 3/22; B29K 2105/26; B29C 48/12; C08L 2207/20; C08L 27/06

(57) ABSTRACT

An extrusion profile (e.g. a coextrusion-profile or monoextrusion-profile) for a window component and/or door component (e.g. a window frame component and/or door frame component or a window wing component and/or door wing component) may include at least one profile surface forming an exterior side of the extrusion profile. The extrusion profile may be made of at least recycling polymer material and be provided with at least one pigmentation including at least one lightfast pigment.

### CROSS REFERENCE TO RELATED APPLICATIONS

This patent application claims priority to German Patent Application No. 10 2020 108 569.9, filed Mar. 27, 2020, which is incorporated herein by reference in its entirety.

### BACKGROUND

### Field

The present disclosure relates to an extrusion profile, such as a mono- or coextrusion profile, for a window component and/or a door component, in particular a window frame component and/or door frame component, or a window wing component and/or door wing component, as well as a method for manufacturing such a profile.

### Related Art

As of now, polymer extrusion profiles for door frames and/or window frames are generally manufactured from raw polymer material, in particular when they are manufactured by means of mono-extrusion. For polymer coextrusion profiles, recycled polymer material, in particular for environmental reasons, is utilized for profile webs and areas not visible on the exterior. As recycling polymer material in the sense of the present disclosure is understood to be inter alia used, previously installed polymer frames, which may be reused after their application, as well as scrap material, which may for example be produced during processing. On the one hand, recycling polymer material is not used for visible exterior or interior outside services of the profiles for optical reasons. On the other hand, it has been shown that recycled polymer material has the disadvantage that it is not as long-lived as raw polymer material, in particular not as resilient against external influences, especially versus ultraviolet radiation.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 an exemplary embodiment of a coextrusion profile according to the disclosure in the sectional view;

FIG. 2 an exemplary embodiment of a coextrusion profile according to the disclosure in the sectional view;

FIG. 3 an exemplary embodiment of a mono-extrusion profile according to the disclosure in the sectional view;

FIG. 4 an exemplary embodiment of a mono-extrusion profile according to the disclosure in the sectional view;

FIG. 5 a schematic illustration of a section of the manufacturing assembly for a mono-extrusion profile according to the disclosure in a side view;

FIG. 6 a schematic illustration of a section of the manufacturing assembly for a mono-extrusion profile according to an exemplary embodiment of the disclosure in a top view;

FIG. 7 a schematic illustration of a section of the manufacturing assembly for a coextrusion profile according to an exemplary embodiment of the disclosure in a side view;

FIG. 8 a schematic illustration of a section of the manufacturing assembly for a coextrusion profile according to an exemplary embodiment of the disclosure in a top view;

FIG. 9 a schematic illustration of an L-shaped arrangement of the extruders of a manufacturing assembly of the coextrusion profile according to an exemplary embodiment of the disclosure in a top view; and

FIG. 10 a schematic illustration of an extruder assembly of an extrusion profile according to an exemplary embodiment of the disclosure including two tools and three extruders in the top view.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

It is an object of the present disclosure to overcome the disadvantages of the prior art, in particular to provide an extrusion profile utilizing recycling polymer material for externally visible profile surfaces, having a resiliency against external influences, such as direct or indirect illumination, which is at the same time not impaired, in particular improved.

The above-mentioned objective is solved according to a first aspect, by providing an extrusion profile, in particular a coextrusion profile or a mono-extrusion profile, for a window component and/or a door component, in particular a window frame component and/or door frame component, or a window wing component and/or door wing component, wherein at least one profile surface forming the exterior of the extrusion profile is made of at least recycling polymer material and provided with at least one pigmentation comprising at least one lightfast pigment. The extrusion profile may for example at least sectionally form a window component and/or door component, such as a holm, such as a vertical holm or a horizontal holm, either of a stationary window component and/or door component, or of a movable, in particular slidable and/or pivotable window wing component and/or door frame component. The extrusion profile may comprise a semi-finished extrusion product having an essentially identical cross section along the extrusion-direction as well as substantially identical exterior dimensions.

The manufacturing of the extrusion profile according to the disclosure may be performed through a mono- or coextrusion process, in which the use of the at least one pigmentation may be limited to a single layer of the at least one profile surface forming the exterior surface of the extrusion profile. This layer may preferably be arranged on the visible surface of the profile. Particularly preferred, a layer of the at least one pigmentation is applied onto the visible surface of the extrusion profile, wherefore small amounts of the at least one pigmentation are required. Thereby, the cost of manufacturing an extrusion profile according to the disclosure is reduced. The individual steps of the manufacturing process will be described in detail below. In the sense of the present disclosure, the term “mono-extrusion profile” shall be understood as a profile made by mono-extrusion. The term “coextrusion profile” shall be understood as a profile made by coextrusion. Coextrusion refers to the joining of 2 polymer melts of the same or different kinds prior to leaving the extrusion tool (nozzle), wherein the two polymer melts are created by two separate extruder devices and joined to a single workpiece in the extrusion tool (nozzle). According to the disclosure, the two polymer melts are presently joined to a coextrusion profile.

Generally, the addition of pigmentation may reduce the rigidity of the profile. Due to this, the manufacturing of the extrusion profile is preferably made via a coextrusion process, because the means of a coextrusion process the corner-rigidity of the extrusion profile may be provided sufficiently even when an additional pigmentation is used. Through the coextrusion method, the application of the thin layer of the at least one pigmentation is enabled. It is of a large advantage for this disclosure, that the application of the thin layer of the at least one pigmentation, the addition of the at least one pigmentation does not have any noticeable, rigidity-reducing influence and to the profile, as the application is reduced to a single, very thin layer. Accordingly, the profiles manufactured according to the disclosure have a sufficient rigidity both in the welding area as well as a sufficient rigidity against shock and breaking.

The term “at least one” in the sense of this disclosure shall be understood as a single substance or a single molecule, or as 2, 3, 4, 5, 6, 7, 8, 9, 10, 11, 12, 13, 14, 15, 16, 17, 18, 19, 20, or any arbitrary number of substances or molecules. Thus, for instance, the term “at least one pigmentation” in the sense of the present disclosure shall be understood as at least one pigmentation, or 2, 3, 4, 5, 6, 7, 8, 9, 10, 11, 12, 13, 14, 15, 16, 17, 18, 19, 20, or any arbitrary number of pigmentations. Furthermore, the term “at least one lightfast pigment” in the sense of the present disclosure shall be understood as at least one lightfast pigment, or 2, 3, 4, 5, 6, 7, 8, 9, 10, 11, 12, 13, 14, 15, 16, 17, 18, 19, 20, or any arbitrary number of lightfast pigments. Furthermore, the term “at least one” in the sense of this disclosure includes any arbitrarily large number of pigmentations and/or lightfast pigments, which are preferably distributed evenly within a layer or on a surface. In the sense of the present disclosure, the term “at least one” shall, however, also include any arbitrarily large number of pigmentations and/or lightfast pigments, which are preferably distributed unevenly within a layer or on a surface.

In an exemplary embodiment of the extrusion profile according to the disclosure, the recycling polymer material is a compound comprising used-window-granules, wherein the used-window-granules comprise a mass fraction between 70 wt-% and 100 wt-% of the compound, in particular between 80 wt-% and 98 wt-% of the compound, between 90 wt-% and 97 wt-% of the compound, or approximately 95 wt-% of the compound.

“Used-window-granules” in the sense of the present disclosure refers to a mixture comprising used, previously installed, polymer frames, which are reused after their application, and/or the polymer material, accrued during a processing method for example at a window manufacturer or when disassembling used windows, mixed with one another during the preparation of used-window-granules. The used, previously installed polymer frames and/or the polymer material, which is accrued in the course of processing, for example at the window manufacturer, or during disassembly of the used windows, may be provided separately.

Preferably, in the sense of the present disclosure, a recycling polymer material is used for an extrusion profile according to the disclosure, as this is advantageous for the environment and as it is a CO2-neutral product. As the recycling polymer material in the extrusion profile according to the disclosure is also used for externally visible profile surface is, the environmental friendliness of the extrusion profiles according to the disclosure is visible externally.

In a further exemplary embodiment of the present disclosure, the used window granules are a material provided by a process comprising the following steps:
i) reducing used window material to small pieces, wherein reducing to small pieces particularly comprises milling or shredding used window material;
ii) separating the used window material which has been reduced to small pieces;
iii) sorting the used window material which is separated and refused to small pieces into different colors;
iv) optionally, pigmenting the used window material which has been sorted, separated reduced to small pieces;
iv) cleaning the used window material that has been pigmented, sorted, separated and reduced to small pieces, wherein cleaning is preferably performed by melt filtration, and
v) granulating used window material which has been cleaned, pigmented, sorted, separated and reduced to small pieces.

In step ii) of the method, preferably physical separation methods or opto-physical-separation methods known to the person skilled in the art, are employed for separation, in order to separate different constituents, such as different metals. In a preferred embodiment, for example iron is separated from non-iron-constituents. In a further preferred embodiment, ceramic constituents are separated from polymers.

In step iii) of the method, the used window material which has been separated and reduced to small pieces is sorted as clean as possible into different color hues. In an exemplary embodiment, the used window material which has been separated and reduced into small pieces is sorted into different white hues, brown hues and colorful hues. The sorting in step iii) of the process is preferably performed through optical color sorting methods known to the person skilled in the art.

The used window granules created by means of the method is according to the disclosure is processed further in order to be provided with at the least one pigmentation. The addition of additives, such as for example the at least one pigmentation, during profile extrusion is performed preferably by means of at least one dosing device in the material conveyance, for example in a funnel, of the extruder or by admixing the at least one pigmentation in an upstream mixing area.

During the used-window-granulation, pigmentation may be problematic prior to melt filtration, because thereby the grain size of the pigment is limited by the mesh-width of the melt filter. Therefore, according to a particularly preferred embodiment, the pigmentation is performed during used-window-granulation only after performing melt filtration.

In a further exemplary embodiment of the extrusion profile according to the disclosure, the compound comprises waste products or profile sections accrued during the extrusion of a profile, for example of a profile of a door frame component and/or a window frame component, in particular a door frame and/or window frame. The waste products or profile sections may according to the disclosure the recycled similarly to the used-window-granules as described above.

In a further exemplary development of the present disclosure, the recycling polymer material is a compound comprising used-window-granules and at least one additive. Preferably, the at least one additive is calcium carbonate, titanium(IV) oxide, a modifying agent, a stabilizing agent, a metal soap, a lubricant, stearate, a fatty acid and/or a pigment. Furthermore, the at least one additive may be a flame retardant, a UV-absorbent, a foaming agent, a bonding agent, mica, kaolin, slate powder, slate grit, aerated slate, antistatics and/or a fungicide.

In the sense of the present disclosure, any common modifying agent may be employed. Preferably, the modifying agent is selected from chlorinated polyolefins, such as chlorinated polyethylene (CPE), polymers of the acrylate type, such as Homo-polymers and copolymers of acrylic acid alkyl ester, acrylate, ethylene-propylene-rubber, shock-resistance-modifying agents of the butadiene type, such as acryle nitrile butadiene styrene (ABS) and/or methyl methacrylate butadiene styrene (MBS), and copolymers of the ethylene with vinyl acetate (EVA).

In the sense of the present disclosure, any common stabilizing agent may be utilized. Preferably, the stabilizing agent is selected from inorganic stabilizing agents based on Cd, Pb, Mg, Sn, Zn, Ca, or Ba, for example a metal soap, such as a barium cadmium soap, a calcium-zinc-soap or a lead soap, a lead salt, an alkyl tin mercapto compound, an alkyl tin carboxylate, are from organic stabilizing agents, such as an epoxidized oil or ester, a diphenyle thiourea, phenylindole, phenol, a bisphenol, an arylic phosphite, an alkyl phosphite, or an aryl-alkyl phosphite.

Preferably, a neutral or alkaline metal soap is a utilized, wherein the metal soap particularly preferred is selected from a metal soap based on Cd, Pb, Mg, Sn, Zn, Ca, and Ba, for example a barium cadmium soap, a calcium tin soap and a lead soap.

In the sense of the present disclosure, any lubricant may be utilized, in particular a lubricant such as glycerin, a fatty acid having a chain length of C12 to C40, a mono-ester, a diester, or a triester of natural or oxidized carbonic acids having a chain length of C12 to C40, a fatty acid having a chain length of C12 to C40, is substituted fatty acid, and oxidized fatty acid, a paraffin oil, a solid paraffin, polyethylene, an oxidized polyethylene a fatty acid amide and a silicone oil.

As stearates shall be considered for example stearates of the metals Cd, Pb, Mg, Sn, Zn, Ca and Ba, phtalic acid esters of long chained alcohols or wax esters, such as for example C10 to C40-alcohols esterified with C12 to C35-acids, or the like.

In the sense of the present disclosure, any fatty acid, in particular fatty acids having a chain length of C12 to C40 can be utilized.

In an exemplary embodiment of the present disclosure, the bonding agent comprises a solvent such as VOC, isobutanol, xylole, ethylbenzene, solved single- or dual-component-resins, in particular epoxy resin, alkyd resin, acrylate resin and/or polyester resin.

Preferably, a pigment is used as an additive which provides the compound with a desired coloring.

In a preferred embodiment, the compound comprises used window granules and ground stock. Particularly preferred, the ground stock is a postindustrial material.

In a further preferred embodiment, a compound is utilized, wherein the compound comprises used window granules and ground stock, wherein the ratio of used-window-granules to ground stock is approximately 30-70%, or approximately 40-60%, or approximately 50-50%, or approximately 60-40%, or approximately 70-30%, or approximately 80-20%.

In a further preferred embodiment, the compound is a “dry blend” compound. The term “dry blend” in the sense of the present application shall be understood as a mixture comprising a recycling polymer material and at least one additive. Particularly preferred, the dry blend mixture consists of at least one recycling polymer material, in particular polyvinyl chloride polymer, calcium carbonate, titanium(IV) oxide, at least one modifying agent, at least one stabilizing agent, at least one metal soap, at least one lubricant, at least one stearate, and/or at least one fatty acid. The dry blend mixture can in accordance to a further preferred embodiment, comprise at least one pigment. By addition of the at least one pigment, the desired coloring of the mixture is enabled.

In the sense of the present application, the term “approximately” is used in order to indicate a certain tolerance of measurement. “Approximately” according to the disclosure means ±10.0%, or ±5.0 %, or ±1.0%, or ±0.5%, or ±0.1%.

In a particularly preferred embodiment, the polymer of the recycling polymer material is a polyvinyl chloride polymer. Preferably, the recycling polymer material is a recycling material of polyvinyl chloride polymer.

According to the disclosure, the pigmentation may comprise any pigment, in particular any lightfast pigment. In a preferred embodiment, the pigmentation comprises at least one organic and/or at least one inorganic pigment.

The term “at least one organic pigment” in the sense of the present disclosure shall be understood as at least one organic pigment, or 2, 3, 4, 5, 6, 7, 8, 9, 10, 11, 12, 13, 14, 15, 16, 17, 18, 19, 20, or any arbitrary number of organic pigments. In the sense of the present disclosure the term “at least one inorganic pigment” shall be understood as at least one inorganic pigment, or 2, 3, 4, 5, 6, 7, 8, 9, 10, 11, 12, 13, 14, 15, 16, 17, 18, 19, 20, or any arbitrary number of inorganic pigments. Furthermore, the term “at least one” in the sense of the present disclosure comprises any arbitrary number of organic and/or inorganic pigments, which are preferably distributed evenly in a layer or on a surface. However, the term “at least one” in the sense of the present disclosure also comprises any arbitrary number of inorganic and/or inorganic pigments, which are preferably distributed unevenly in a layer or on a surface.

In a further preferred embodiment, a compound is used, wherein the compound comprises recycling polymer material and at least one pigmentation. Preferably, the ratio of recycling polymer material to the at least one pigmentation is approximately 20-80%, or approximately 30-70%, or approximately 40-60%, or approximately 50-50%, or approximately 60-40%, or approximately 70-30%, or approximately 80-20%. Particularly preferred, the mixture comprises 15-50% recycling polymer material and 25-50% of the at least one pigmentation. In an exemplary embodiment, the mixture comprises 25-35% recycling polymer material and 30-35% of the at least one pigmentation. This mass-ratio between recycling polymer material and the at least one pigmentation in relation to the external, visible profile surface provides for a reliable extrusion and a sufficient rigidity of the extrusion profile.

In a particularly preferred embodiment, the at least one organic pigment comprises a mass ratio between 0.01 wt % and 10.00 wt % of the compound, in particular between 0.10 wt % and 5.00 wt % of the compound, between 0.50 wt % and 1.00 wt % of the compound or approximately 0.80 wt % of the compound. In the sense of the present disclosure, the term “at least one organic pigment” also includes combinations of different organic pigments. The term “at least one organic pigment” in the sense of the present disclosure may thus asides from a singular organic pigment alternatively comprise 2, 3, 4, 5, 6, 7, 8, 9, 10, 11, 12, 13, 14, 15, 16, 17, 18, 19, 20, or any arbitrary number of different organic pigments.

In a further embodiment, the at least one organic pigment is selected from azo-pigment, a phthalocyanine-pigment, a quinacridone-pigment, a varnish-pigment, carbon black, and a combination thereof.

In an exemplary embodiment, the at least one inorganic pigment comprises a mass fraction between 10 weight % and 50 weight % of the compound, in particular between 20 weight % and 40 weight % of the compound, between 25 weight % and 35 weight % of the compound or approximately 32 weight % of the compound.

In an exemplary embodiment, the at least one inorganic pigment is selected from an iron oxide, an iron hydroxide, a zinc ferrite, a zinc oxide, a magnesium ferrite, a manganese ferrite, a cadmium sulfide, chromium(III)-oxide, chromium(III)-oxide-hydrate, chrome oxide green (PG17), chrome oxide hydrate green (PG18), cobalt zincate (CoZn02), malachite (Cu2Co3(OH)2), copper(II)arsenide (CuHAsO3), arsenic(III) sulfide (As2S3), vanadium yellow (PY184), bismuth vanadate (BiVO4), and cadmium yellow (PY37), and a combination thereof.

In an exemplary embodiment, the compound additionally comprises at least one substance selected from the group consisting of:
(i) a mineral filler component, such as for example calcium carbonate, talcum, mica, wollastonite, silica, kaolin, magnesium silicate, aluminium magnesium silicate, potassium aluminium silicate, MicaCelia, graphite, slate, glass fiber, or dolomite,
(ii) a mineral pigment, such as for example titanium(IV)oxide (TiO2), zirconium(II)oxide (ZrO), cerium(III)oxide (Ce2O3), cadmium sulfide (CdS), calcium ascorbate (CaAs), zirconium(IV)oxide (ZrO2), iron(I)oxide (Fe2O), iron(II)oxide (FeO), iron(III)oxide (Fe2O3), or silicone dioxide (SiO2),
(iii) a polyesterizing agent polymer composition;
(iv) a copolymer, such as for example a copolymer of ethylene and vinyl acetate (EVA),
(v) a lubricant, such as for example glycerine, a fatty acid, an amino acid, a paraffin oil, a paraffin, polyethylene, a fatty acid amide, or a silicone oil,
(vi) a polyvinyl chloride, such as for example K65-polyvinyl chloride, K66-polyvinyl chloride, K67-polyvinyl chloride, K68-polyvinyl chloride, or K69-polyvinyl chloride;
(vii) an ester, such as for example a phthalic acid ester (phthalate), diallyl phthalate, di-2-ethylhexyle phthalate, di-isooctyl phthalate, or tetrabrom dioctyl phthalate; and
(viii) a modifying agent, a stabilizing agent, a metal soap, a stearate, a fatty acid, a pigment, a flame retardant, the UV-absorbent, a foaming agent, or an adhesion agent.

In the sense of the present disclosure, any common mineral filler component may be used. Preferably, calcium carbonate, talcum, mica, wollastonite, silica, kaolin, magnesium silicate, aluminum magnesium silicate, potassium aluminum silicate, mica, MicaCelia, graphite, slate, such as slate powder, slate grid or aerated slate, glass fiber, or dolomite is used as the mineral filler component.

In the sense of the present disclosure, any common mineral pigment may be used. Preferably, the mineral pigment is selected from titanium(IV)oxide (TiO2), zirconium(II)oxide (ZrO), cerium(III)oxide, cadmium sulfide (CdS), calcium ascorbate (CaAs), zirconium(IV)oxide (ZrO2), iron(II)oxide (FeO), iron(III)oxide (Fe2O3), and silicone dioxide (SiO2).

In the sense of the present disclosure, any common polyesterizing agent polymer composition can be used.

In the sense of the present disclosure, any common copolymer can be used. Preferably a copolymer of ethylene with vinyl acetate (EVA) is used.

In the sense of the present disclosure, any lubricant can be used, in particular a lubricant like glycerin, a fatty acid having a chain length of C12 to C40, a monoester, at diester, or a triester of natural or oxidized carbonic acids having a chain length of C12 to C40, a fatty acid having a chain length of C12 to C40, a substituted fatty acid, an oxidized fatty acid, a paraffin oil, a solid paraffin, polyethylene, an oxidized polyethylene, a fatty acid amide or a silicone oil.

In the sense of the present disclosure, any common polyvinyl chloride can be used. Preferably, the polyvinyl chloride is used as a carrier substance, wherein the polyvinyl chloride is preferably K65-polyvinyl chloride, K66-polyvinyl chloride, K67-polyvinyl chloride, K68-polyvinyl chloride, or K69-polyvinyl chloride.

In the sense of the present disclosure, any ester can be used. Preferably, the ester is selected from a phthalic acid ester (phthalate), diallyl phthalate, di-2-ethylhexyle phthalate, di-isooctyl phthalate, or tetrabrom dioctyl phthalate. Preferably, the phthalate is free of softening agents.

In an exemplary embodiment, the compound comprises an organic pigment, an inorganic pigment, and a mineral pigment, preferably titanium(IV)oxide (TiO2), wherein optionally the compound additionally comprises a mineral filler component, a polyesterizing agent polymer composition, a polyvinyl chloride, and/or an ester, preferably a phthalic acid ester (phthalate).

In an exemplary embodiment, the organic pigment comprises a mass fraction between 0.5 wt-% and 1.5 wt-%, the inorganic pigment a mass fraction of between 25.0 wt-% and 35.0 wt-%, the mineral pigment, in particular titanium(IV) oxide (TiO2), a mass fraction between 20.0 wt-% and 30 wt-%, the mineral filler component a mass fraction between 0.0 wt-% and 35.0 wt-% of the compound, the polyesterizing agent polymer compound a mass fraction between 0.0 wt-% and 45 wt-%, and the ester, preferably a phtalic acid ester (phthalate), comprises a mass fraction between 0.0 wt-% and 30.0 wt-% of the compound.

In an exemplary embodiment, the organic pigment comprises a mass fraction of approximately 0.8 wt %, the inorganic pigment a mass fraction of about 32.0 wt %, titanium(IV)oxide (TiO2) a mass fraction of approximately 24.0 wt %, the mineral filler component a mass fraction of approximately 10.2 wt % and the polyesterizing agent polymer compound a mass fraction of about 33.0 wt % of the compound. In this exemplary embodiment, the compound is highly concentrated.

In an exemplary embodiment, the organic pigment comprises a mass fraction of approximately 0.8 wt %, the inorganic pigment a mass fraction of about 32.0 wt %, titanium(IV)oxide (TiO2) a mass fraction of approximately 24.0 wt %, the polyvinyl chloride a mass fraction of approximately 24.0 wt %, almost the laws the members of the polyesterizing agent polymer compound a mass fraction of about 19.0 wt % and the mineral filler component a mass fraction of approximately 0.2 wt % of the compound. In this exemplary embodiment, the compound is mildly concentrated.

Furthermore it has been found out that recycling polymer material which may for example comprise used window granules, has disadvantaged that it is not as long living as raw polymer material, in particular not as resilient with respect to external influences, especially against UV radiation. Therefore, fundamental conflict of interest occurs between on the one hand the desire to provide an extrusion profile for a window component and/or door component, having at least one exterior surface of the extrusion forming a profile surface made of an environmentally friendly recycling polymer material, and on the other hand the provision of an extrusion profile for a window component and/or door component, which is long living and resilient against external influences, especially against UV-radiation. Through the measurements according to the disclosure, namely pigmentation of the at least one profile surface forming an exterior surface of the extrusion profile, with at least one lightfast pigment, this conflict of interest can be solved reliably in an economic manner.

A further advantage is present in that the at least one pigmentation of the at least one profile surface forming an exterior surface of the extrusion profile increases the reflection of the radiation, in particular an UV-radiation, in the extrusion profile for a window component and/or door component, in particular a window frame component and/or door frame component or a window wing component and/or door wing component. Thus, the pigmentation of the at least one profile surface forming an outside surface of the extrusion profile with at least one lightfast pigment, allows the provision of an extrusion profile for a window component and/or door component, for which the at least one profile surface forming at least one outside surface of the extrusion profile is made from a recycling polymer material, which is more environmentally friendly and more CO2 neutral, nevertheless long living, lightfast and resilient against external influences, especially against UV-radiation.

In the sense of this disclosure, the term “lightfastness” is used as a grade for the lightfastness of a material, in particular of a surface material. For determining the lightfastness, it is analyzed if the colors of the material, in particular of the surface material, fade and/or change color upon direct or indirect illumination. Lightfast materials, in particular surface materials, do not or barely lose any of their color intensity even in case of direct sunray illumination. Particularly sunlight having a large proportion of UV-light, however, has a degrading effect on many materials, in particular surface materials, which may lead to visible discolorations. Such discolorations do not only have a esthetic but also technical disadvantages.

Depending on the kind of light, ultraviolet (UV) radiation and infrared (IR) radiation of different intensity acts onto extrusion profiles, for example made of polymers, for window components and/or a door components, in particular window frame components and/or door frame component or window wing components and/or door wing components. As such extrusion profiles are continuously exposed to environmental conditions, in particular to UV-radiation, for long times, these rays can during the course of time cause reactions in the polymer material that may lead to embrittlement and/or fading of the materials, in particular surface materials.

The lightfastness may, according to the disclosure, be determined through any means known to the skilled person. For example the lightfastness can be determined by the illumination process according to DIN 2015: A02, wherein the color temperature is measured for a total illumination power of for example approximately 12 GJ/m² in a wavelength spectrum from approximately 300 nm to 800 nm. The individual steps of the process for determining the lightfastness and fastness to weathering are explained in detail in the examples below.

It has been found out that recycling polymer material has a lightfastness that cannot sufficiently establish a desired fastness to weathering and lightfastness of an extrusion profile for a window component and/or door component, in particular a window frame component and/or door frame component or a window wing component and/or door wing component. Furthermore it has been found out that by providing the inventive addition of the at least one pigmentation, which comprises at least one lightfast pigment, it is possible to substantially improve the lightfastness of the extrusion profile according to the disclosure made of recycling polymer material, and thus provide long living and provide extrusion profiles for a window- and/or door component with resiliency in particular against environmental influences, especially against UV-radiation.

In an exemplary embodiment of the present disclosure, the at least one pigmentation comprising at least one lightfast pigment of the at least one profile surface forming an external surface of the extrusion profile enables the provision of an extrusion profile for a window component and/or door component having at least one profile surface made of recycling polymer material forming an outside of the extrusion profile, wherein a lightfastness of the at least one profile surface of at least recycling polymer material, forming an outside of the extrusion profile is increased to a lightfastness grade of at least 4, preferably 5, more preferred 6, even more preferred 7, and most preferred the lightfastness grade 8, of a blue scale, or a lightfastness grade 2, preferably 3, most preferred the lightfastness grade 4, of a grey scale. The lightfastness grade of the grayscale is determined according to the disclosure preferably according to a DIN 2015-A02 process.

In an exemplary embodiment of the profile according to the disclosure, the at least one pigmentation comprising at least one lightfast pigment, of the at least one profile surface forming an outside surface of the extrusion profile, enables the provision of an extrusion profile for a window component and/or door component having at least one profile surface made of recycling polymer material forming an outside surface of the extrusion profile, and wherein the at least one profile surface forming an outside surface of the extrusion profile having a lightfastness grade of at least 4, preferably 5, more preferred 6, even more preferred 7 and most preferred lightfastness grade 8, of the blue scale, or a lightfastness grade 2, preferably 3, most preferably light fastness grade 4, of a grayscale. The lightfastness grade according to the grayscale is according to the disclosure preferably determined according to a DIN 2015-A02 process.

In an additional embodiment of the extrusion profile according to the disclosure, the at least one pigmentation comprising at least one lightfast pigment increases the reflection of a radiation, in particular of a UV radiation, of the door and/or window frame component, wherein the at least one pigmentation comprising at least one lightfast pigment protects the at least one profile surface made of at least recycled polymer material which forms an outside of the extrusion profile from weathering due to radiation, in particular UV-radiation.

According to a further aspect of the present disclosure, which may be combined with previous aspects and exemplary embodiments, the above-mentioned objective is solved according to a second aspect by providing a process for manufacturing an extrusion profile, with which at least one profile surface forming an exterior surface of the extrusion profile is made of a polymer recycling method by means of extrusion, in particular by means of coextrusion or mono-extrusion, and provided with at least one pigmentation comprising at least one lightfast pigment.

According to the disclosure, the manufacturing of the extrusion profile is preferably performed via a coextrusion process, as coextrusion can be utilized to limit the use of the at least one pigmentation to a single layer of the at least one profile surface forming an exterior surface of the extrusion profile. This layer is preferably arranged on the visible surface of the profile. Particularly preferred, one layer of the at least one pigmentation is applied onto the visible surface of the extrusion profile, wherein a low amount of the at least one pigmentation is required. Thereby, the cost for manufacturing an extrusion profile according to the disclosure are reduced. Additionally, the rigidity of the profile in the welding area, as well as the rigidity of the profile against impact and breaking is improved.

In an exemplary embodiment, the process for manufacturing an extrusion profile comprises the step of dosing the at least one pigmentation, wherein the dosing of the at least one pigmentation is performed by addition of the at least one pigmentation to the recycling polymer material through a dosing device, for example a volumetric and/or gravimetric dosing device.

In an exemplary embodiment, the at least one pigmentation comprising at least one lightfast pigment increases the lightfastness of the at least one profile surface made of at least recycling polymer material forming an exterior surface of the extrusion profile, to a lightfastness grade of at least 4, preferably 5, more preferably 6, even more preferred 7, and most preferred the lightfastness grade 8, of a blue scale, or to a lightfastness grade 2, preferably 3, most preferred the lightfastness grade 4, of a grayscale. The lightfastness scale according to the grayscale is according to the disclosure a preferably determined in a DIN 2015/A02 process.

In a preferred embodiment, the lightfastness of the at least one profile surface forming an exterior surface of the extrusion profile is determined by a method comprising the following steps:
(i) illuminating a grading sample and a first component of the profile surface, wherein a second part of the profile surface is covered,
(ii) comparing the first component of the profile surface with the second part of the profile surface and the grading sample, and
(iii) determining the lightfastness grade.

In an exemplary embodiment, the lightfastness grade according to the grayscale is determined in a DIN 2015-A02 process.

Especially preferred is an exemplary embodiment, wherein the lightfastness of the at least one profile surface forming an exterior surface of the extrusion profile is determined by a process comprising the following steps:
(i) illuminating a grading sample having four steps, and a first section of the profile surface, wherein a second section of the profile surface is covered,
(ii) comparing the first section of the profile surface to the second section of the profile surface and to the grading sample having four steps,
(iii) determining a lightfastness grade, wherein the lightfastness grade has four steps, and wherein the lightfastness grade may be for example 1, 2, 3, or 4.

The term “steps” in the sense of the present disclosure refers to any kind of increment, division or scale applicable to divide a value.

The present disclosure also refers to a door frame and/or window frame as well as a door wing and/or a window wing having at least one holm manufactured by the process according to the disclosure or formed by a profile according to the disclosure.

According to a further aspect of the present disclosure that may be combined with previous aspects and exemplary embodiments, the preceding objective is solved according to a further aspect by using at least one pigmentation comprising at least one lightfast pigment for stabilizing a recycling polymer material against the influence of light and/or warmth onto the lightfastness, in particular against hue shift and/or light-induced fading of a recycling polymer material.

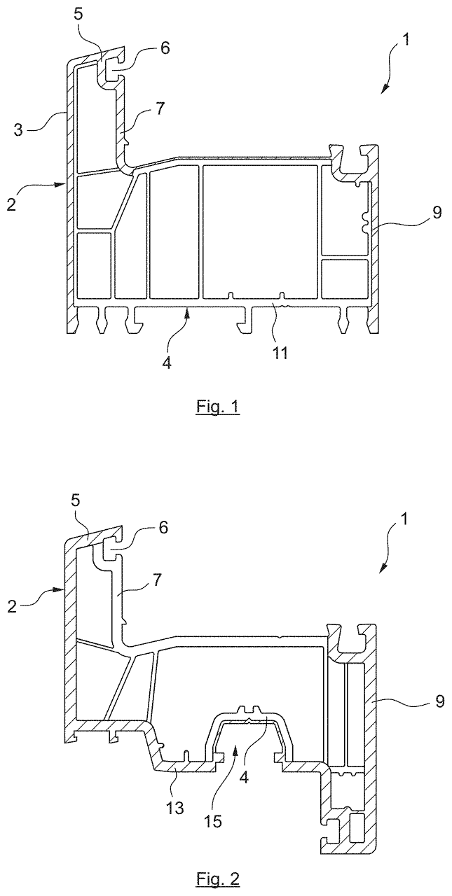

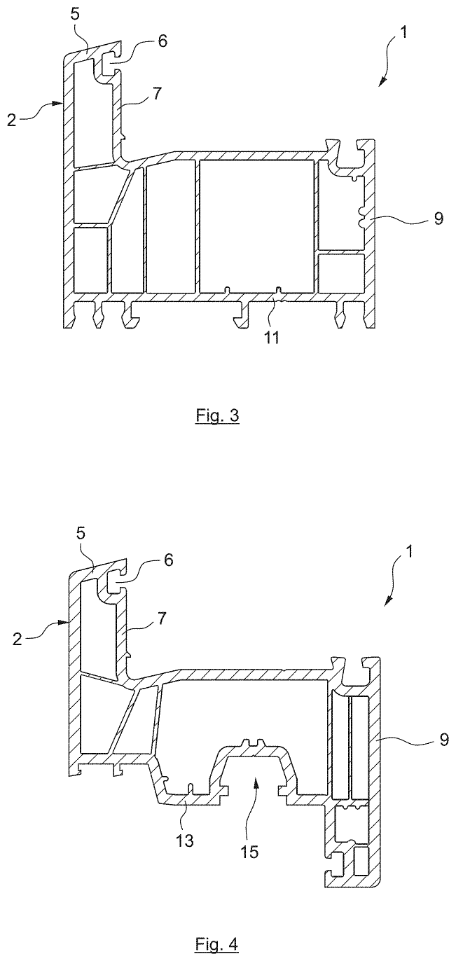

Referring to FIGS. 1 through 4, embodiments of an extrusion profile according to the disclosure will be described, which is generally designated with reference numeral 1. The exemplary embodiments of extrusion profile is 1 according to the disclosure according to FIGS. 1 through 4 are exemplarily extrusion profiles 1 made of recycling polymer material, in particular PVC-recycling polymer material. The extrusion can be performed by means of coextrusion (FIGS. 1 and 2) or mono-extrusion (FIGS. 3 and 4). FIG. 1 and FIG. 2 both show exemplary embodiments of the extrusion profile 1 according to the disclosure in the sectional view. The exemplary embodiments of an extrusion profile 1 in FIG. 1 and FIG. 2 are designed as a coextrusion profile. In the FIGS. 3 and 4, exemplary embodiments of extrusion profiles 1 according to the disclosure are designed as mono-extrusion profiles.

### Example 1: Exemplary Embodiments of Extrusion Profiles in a Coextrusion Profile According to the Disclosure

Referring to FIG. 1, an extrusion profile 1 made by coextrusion is described, which may for example form at least one horizontal or vertical holm of the stationary door frame component and/or window frame component. The profile surface forming an exterior of the extrusion profile 1 is provided with reference numeral 2. This at least one profile surface 2 forming an exterior surface of the extrusion profile 1 is made from at least recycling polymer material and provided with at least one pigmentation having at least one lightfast pigment. The manufacturing process of the extrusion profile 1 will be explained in more detail below. The at least one profile surface 2 forming an outside of the extrusion profile 1 is additionally highlighted by a hatching in FIGS. 1 and 2. The profile surface 2 in particular comprises those profile webs of the extrusion profile 1 which are externally visible, in particular when the extrusion profile 1 is integrated into the door frame component and/or window frame component. The relevant profile webs include for example an exterior profile web 3 facing towards or to be faced towards the environment and/or the building exterior, a sealing web 5 inclined with respect to the exterior profile web 3 which is provided to seal against a glazing (not shown), an essentially L-shaped glazing-web 7 for receiving the glazing, and an interior profile web 9 connecting to the glazing web 7, facing towards or to be faced towards the building interior. Thereby it is provided that the extrusion profile 1 has the desired look, in particular a recycling-look. The glazing web 7 may alternatively be a support web when the extrusion profile 1 is utilized for a free standing door frame component and/or window frame component of a slidable system or a lift-up sliding system, wherein the support web 7 in this case serves to support or receive the door wing component and/or a window wing component movable in relation to the door frame component and/or window frame component.

The extrusion profile 1 furthermore comprises a profile base 4 manufactured in a single manufacturing step together with the profile surface 2, in particular by means of coextrusion. The profile base 4 can be made of any arbitrary recycling polymer material, for example of used polymer window granules, such as used PVC polymer window granules. In FIG. 1 it is shown that the profile basis 4, except for the area of the bottom web 11 forming the underside of the door frame component and/or window frame component, is not visible from the outside. The profile basis 4 is, except for the bottom web 11, completely encased or surrounded by the profile surface 2.

The extrusion profile 1 comprises an essentially L-shaped exterior contour in the sectional view in FIG. 1. The individual profile webs of the profile surface 2 are thereby made from a single piece by extrusion and, along with their direction of extrusion (in the plane of the drawing), comprise an essentially constant wall thickness and/or cross-sectional dimension. In the area of the sealing web 5, a seal reception 6 is provided for a glazing seal for sealing a sealing slot between the glazing and the sealing web 5 or the glazing web 7 (not shown).

In the fundamental design, the extrusion profile 1 according to FIG. 2 is configured or manufactured in analog to the extrusion profile 1 according to FIG. 1. Unlike FIG. 1, the extrusion profile 1 according to FIG. 2 forms a movable, in particular translationally slidable or pivotable, door wing component and/or window wing component. Also, the extrusion profile 1 for the movable door wing component and/or window wing component according to FIG. 2 is made by means of coextrusion, and comprises a profile surface 2 made of at least a recycling polymer material and provided with at least one pigmentation, as well as a profile base 4 made of any arbitrary polymer material, wherein the profile base 4 and the profile surface 2 are made in a single manufacturing step by coextrusion. Unlike the embodiment according to FIG. 1, the extrusion profile 1 of the door wing component and/or window wing component according to FIG. 2 includes the glazing web 7 at least partially being part of the profile base 4. A further difference is present in that, a fitting web 13 to be faced towards a stationary door frame component and/or window frame component, which forms the underside of the extrusion profile 1, is part of the profile surface 2. The profile surface 2 as well as the profile base 4 comprise a fitting grove 15 for a fitting of the door system and/or window system (not shown).

An advantage of the exemplary embodiment of an extrusion profile according to the disclosure according to FIG. 1 and FIG. 2 is in particular that the profile surface 2 which is made of at least recycling polymer material and provided with at least one pigmentation, forming an exterior side of the extrusion profile, is form-fit with regard to the profile base for forming the underside of the extrusion profile 1, such that a particularly compact structure is provided. Furthermore, the at least one profile surface 2 forming an exterior side of the extrusion profile may be dimensioned such that the same essentially exclusively forms the visible area of the corresponding profile webs of the extrusion profile 1. The profile base 4 and the profile surface 2 may be positively and/or frictionally connected to one another.

In comparison to extrusion profiles according to the prior art, the extrusion profile 1 according to the disclosure may include pigmentation limited to a single layer of the at least one profile surface 2 highlighted as hatched, forming the exterior side of the extrusion profile, which is formed by at least recycling polymer material and provided with a pigmentation. This layer comprising at least one pigmentation is preferably arranged on the visible surface of the profile, that is, on an exterior side facing away from the building interior. In spite of low amounts of the at least one pigmentation, the application of a single, thin layer provides the at least one profile surface forming the outside of the extrusion profile and highlighted as hatched the recycling polymer material extrusion profile with a special long livity, lightfastness and resiliency against environmental influences, especially against UV-radiation.

### Example 2: Exemplary Embodiments of Extrusion Profiles According to the Disclosure in the Mono-Extrusion Profile

FIG. 3 and FIG. 4 show a further exemplary embodiment of an extrusion profile according to the disclosure in the sectional view, which is generally designated with reference numeral 1 and configured as a mono-extrusion profile in FIG. 3 and FIG. 4. In order to avoid redundancies, the same components are indicated with the same term as in FIGS. 1 and 2.

Unlike the previous embodiment of an extrusion profile according to the disclosure according to FIGS. 1 and 2, the example shown in FIG. 3 and FIG. 4 of the extrusion profile 1 according to the disclosure, the extrusion profile 1 is made completely from the polymer recycling material forming the profile surface 2 having at least one pigmentation, namely, in one manufacturing step by means of mono-extrusion. Thereby, the embodiment according to FIG. 3 in analog with the embodiment according to FIG. 1, is an extrusion profile 1 for a stationary door frame component and/or window frame component, and in the embodiment according to FIG. 4 and analog with FIG. 2, an extrusion profile 1 for a movable door wing component and/or window wing component. The examples shown in FIG. 3 and FIG. 4 of the extrusion profile 1 according to the disclosure, thus, have an environmentally friendly recycling polymer material look and yet a special lightfastness and resiliency especially against UV-radiation, but also on their exterior side comprise the same environmentally friendly polymer recycling material look and the same lightfastness and resiliency, especially against ultraviolet radiation, due to the addition of the at least one pigmentation.

The exemplary embodiment of extrusion profiles 1 according to the disclosure according to FIGS. 3 and 4 show a thoroughly hatched extrusion profile 1, as the mono-extrusion profile consistently uses the recycling polymer material which is provided with at least one pigmentation in the one-piece extrusion profile 1.

### Example 3: Manufacturing Process for Extrusion Profiles According to the Disclosure

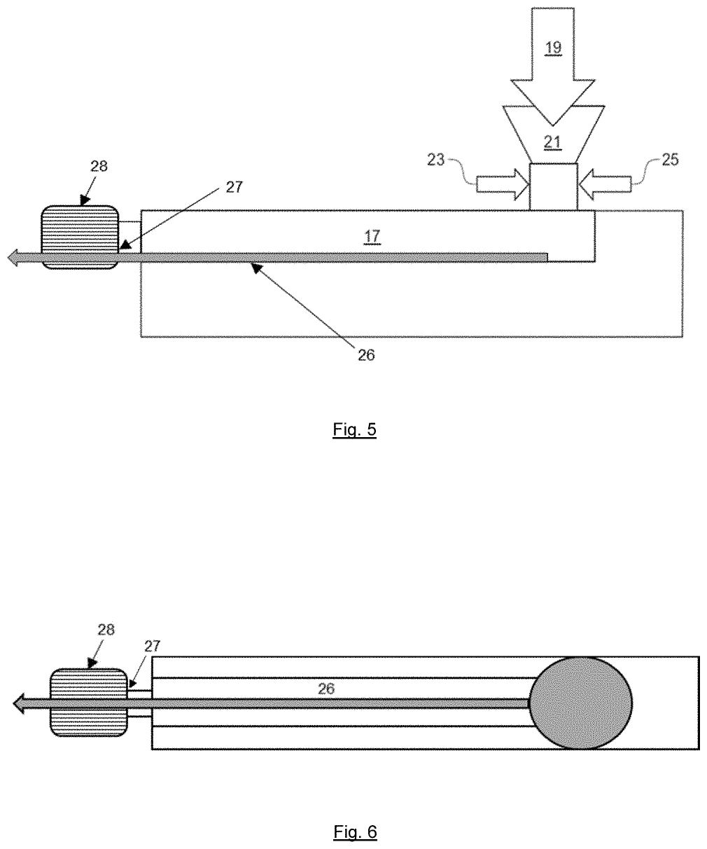

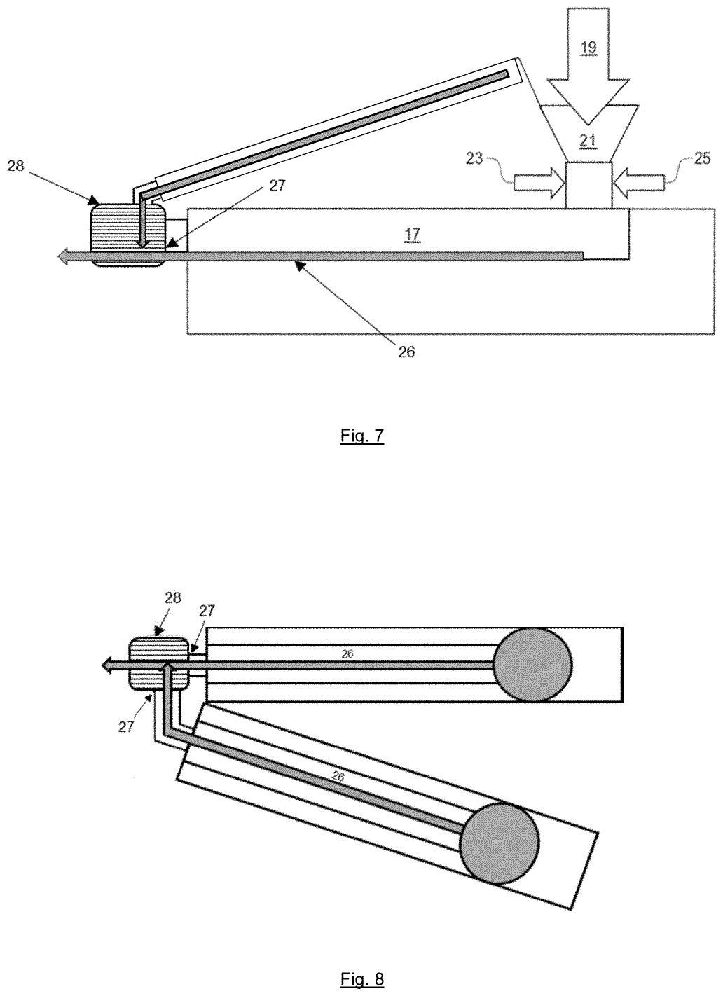

Referring to FIGS. 5 through 10, embodiments of the manufacturing process for making an extrusion profile according to the disclosure are described. The exemplary embodiments of the manufacturing process in FIGS. 5 through 10 realize manufacturing processes of extrusion profiles of recycling polymer material, in particular PVC-polymer-recycling material. The extrusion can be performed by mono-extrusion (FIGS. 5 and 6) or by means of coextrusion (FIG. 7-10).

Referring to FIG. 5, the manufacturing process for making an extrusion profile 1 according to the disclosure and in particular the manufacturing step of compounding or admixing the at least one pigmentation in the extrusion process is schematically illustrated and will be explained in further detail in the following: FIG. 5 shows a section of an extrusion assembly 17 for making an extrusion profile 1 according to the disclosure in the side view. In a feeding area 19, illustrated by the arrow 19, recycling polymer material, for example recycling polymer material being used-window-granules, is introduced. Fundamentally, the recycling polymer material is processed according to the disclosure to obtain at least one pigmentation. Therefore, by means of a material funnel 21, the recycling polymer material is transported further and provided with additives, such as the at least one pigmentation. By admixing the at least one pigmentation during profile extrusion, the recycling polymer material obtains the desired lightfastness and resiliency against weather, especially against UV-radiation. According to the disclosure, a dosed addition of the at least one pigmentation to the recycling polymer material is performed by at least one dosing device which are schematically indicated by arrows having the reference numbers 23, 25. The dosing device 23, 25 may for example be a volumetric and/or gravimetric dosing device.

By using a dosed addition of the at least one pigmentation during profile extrusion by means of the dosing devices 23, 25, the pigmentation with at least one lightfast pigment can be controlled precisely. Furthermore, an essential advantage of the manufacturing process according to the disclosure is that the at least one pigmentation can be limited to a single layer of the at least one profile surface forming the outside surface of the extrusion profile. This layer is situated preferably on the visible surface of the profile, that is, on an outside facing away from the building interior space. In spite of small amounts of the at least on pigmentation, the process according to the disclosure enables the recycling polymer material to provide the recycling polymer extrusion profile due to the layered application of the at least one pigmentation with the desired lightfastness and whether-resiliency, especially against UV-radiation. Hereby, the cost of manufacturing an extrusion profile according to the disclosure may be reduced which would additionally be incurred by the use of increased amounts of the at least one pigmentation.

Fundamentally, the addition of the at least one pigmentation to the profile may lead to a reduction of rigidity of the profile. By employing the manufacturing process for the extrusion profile 1 according to the disclosure, the application of a thin layer of the at least one pigmentation is enabled. By applying a thin layer of the at least one pigmentation, the addition of the at least one pigmentation to the profile has no noticeable rigidity-reducing influence on the profile, as the addition is reduced to a single, very thin layer. Thus, the profiles manufactured according to the disclosure comprise a sufficient rigidity both in the welding area as well as a sufficient impact-and breaking-rigidity.

FIG. 6 shows a schematic illustration of a section of the manufacturing assembly for a mono-extrusion profile according to the disclosure in the top view. The flowing direction of the polymer melt is indicated by means of the gray arrow provided with reference numeral 26. The flange for attaching the tool (nozzle) to the extruder is indicated with reference numeral 27. The extrusion tool (nozzle) in which the extrusion profile is shaped, is provided with the reference numeral 28 and highlighted by means of hatching. A substantial advantage of the manufacturing process for an extrusion profile according to the disclosure is provided in that the at least one pigmentation is limited to a single layer of the at least one profile surface forming the outside of the extrusion profile. This layer is preferably arranged in the vision surface of the profile, that is, on an outside facing away from the building interior space. In spite of small amounts of the at least one pigmentation, the method according to the disclosure enables the polymer extrusion profile to obtain a sufficient lightfastness due to the layered application of the at least one pigmentation. Thereby, the cost of production of an extrusion profile according to the disclosure can be reduced, which would result from using larger amounts of the at least one pigmentation.

In relation to FIG. 7, the manufacturing process for creating an extrusion profile 1 according to the disclosure, in particular a coextrusion profile, as well as the manufacturing step of admixing the at least one pigmentation during the coextrusion process, is schematically illustrated and will be described in more detail below. In FIG. 7, the same components are provided with the same terms as in the FIGS. 1 to 6. FIG. 7 shows a section from an extrusion assembly 17 for manufacturing and extrusion profile 1 according to the disclosure, in a side view. In an entry section 19, indicated by means of the arrow 19, recycling polymer material is introduced. The recycling polymer material is then processed according to the disclosure to obtain at least one pigmentation. Therefore, by means of at least one material funnel 21, the recycling polymer material is transported further as a polymer melt, and joining the recycling polymer material with additions, such as the at least one pigmentation, is performed through coextrusion. The two melts are created in two separate extruder assemblys (extruders, 17) and joined together in the extrusion tool (nozzle, 28) to an extrusion profile.

Fundamentally, to extruders may for example be arranged in a V-arrangement (adjacently offset above one another) or in a piggyback arrangement (directly above one another). According to the disclosure, the arrangement of the two extruders relative to one another is such that one single strain tool or double strain tool, or to double strain tools, can be attached to one another across distances as short as possible such that the two melts may be formed inside the tool or inside the tools to one or two profiles.

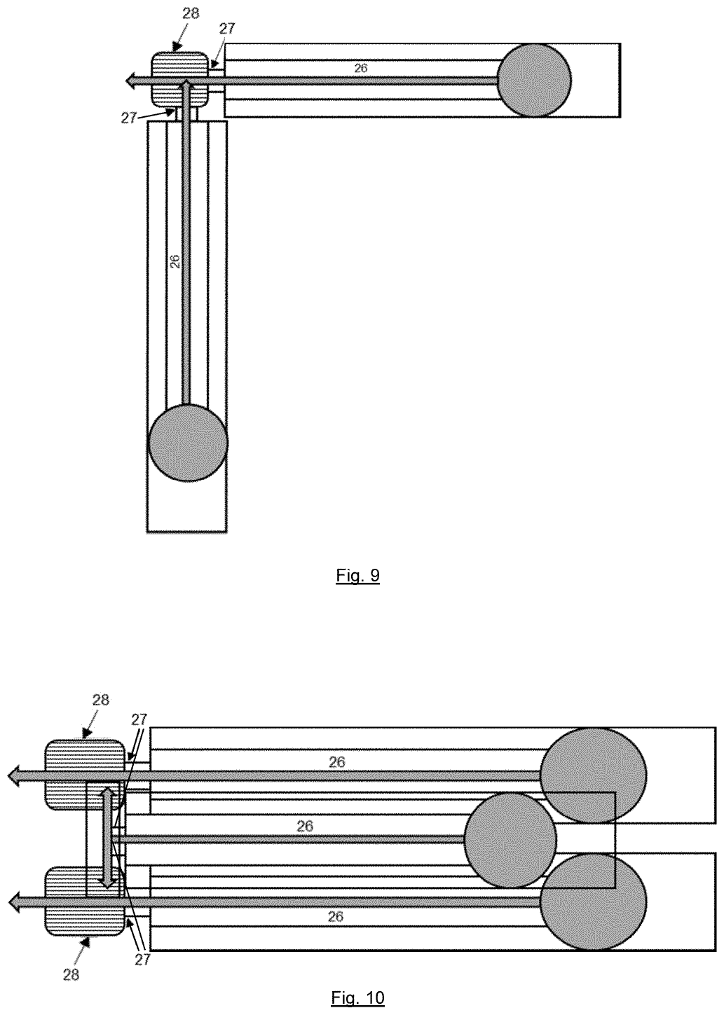

Referring to FIGS. 8 through 10, embodiments of the manufacturing process for creating a coextrusion profile according to the disclosure are described. The exemplary embodiments of the manufacturing process in FIGS. 8 through 10 are different possible arrangements of different extruders in an extrusion assembly 17. FIG. 8 shows a V-shaped arrangement of two extruders in an extrusion assembly 17 for a manufacturing process for making an extrusion profile 1 according to the disclosure in a top view. In a further exemplary embodiment of the manufacturing process for manufacturing and coextrusion profile according to the disclosure, the arrangement of two extruders in an extrusion assembly 17 for a manufacturing process for making an extrusion profile 1 according to the disclosure are arranged in an L-shape, as is shown schematically in the top view in FIG. 9. FIG. 10 shows a schematic illustration of an extrusion assembly 17 with two tools and three extruders in the top view.

### Example 4: Determination of the Lightfastness

The lightfastness of a material can be determined by any process known to the skilled person. For instance, the lightfastness can be determined according to ISO-regulations, for example according to ISO-regulation number 2135-1984 or according to ISO-guideline number 105B02 by dry illumination of the material.

During the process according to ISO guideline number 2135-1984 or according to ISO-guideline number 105 B02 a part of the material, in particular of the surface material, is illuminated within for example an AtlasWeather-O-meter 65 WRC or in an AtlasWeather-O-meter Ci 35 A in illumination cycles of for instance 100 hours each of normal illumination by means of a xenon arc lamp. According to the disclosure, however, any other common illumination device can be used for illuminating the material, in particular the surface material. Furthermore, the use of a xenon arc lamp is not compulsory for the detection of the lightfastness according to the disclosure. Any other common lamp can also be used according to the disclosure. The illumination cycles of for example 100 hours normal illumination each merely realizes a guiding value. The skilled person is aware that an ideal number and division of illumination cycles which may deviate from 100 hours of normal illumination, be selected and they shall not be limited to the detection of the lightfastness to a single method.

During the process, the first part of the material, in particular of the surface material, is illuminated, whereas the second part of the material, in particular of the surface material, is covered and thus not illuminated. A comparison of the illuminated material, in particular the surface material, with a grading sample, which may for example consist of a scale of eight blue wool strips or four gray wool strips of different lightfastnesses that enable the analysis of the lightfastness of the material to be tested, in particular of the surface material. Therefore, the grading sample, which may for example consist of a scale of eight strips or of four strips of different lightfastnesses, may be subjected to the illumination to gather with the material to be tested, in particular the surface material, wherein the illuminated material is compared to the cover material. The lightfastness is then determined based on the difference between the illuminated material section, covered material section and the illuminated grading sample.

The lightfastness can be determined in a scale including 8 steps (so-called “blue scale”):

lightfastness 8: magnificent

lightfastness 7: excellent

lightfastness 6: very good

lightfastness 5: good

lightfastness 4: rather good

lightfastness 3: moderate

lightfastness 2: poor

lightfastness 1: very poor

A lightfastness of grade 7 or 8 means that barely any or a barely visible difference between the illuminated material section and the covered material section is distinguishable. On the other hand, for a lightfastness of step 6 or smaller, a significant difference between the illuminated material section at the covered material section is distinguishable. Within the lightfastness scale, from one step to another, the time for which the material may be subjected to light approximately doubles without any change in the material. For example, in case a lightfastness grade according to grade 6 according to the blue scale is achieved after 2 illumination cycles, the material is graded according to a lightfastness grade of 7. However, if the lightfastness grade according to grade 6 of the blue scale is only achieved after 4 illumination cycles, the material is graded according to a lightfastness grade of 8.

The lightfastness of most pigments is to be ranked as 7 or higher. Inclusion of at least one pigmentation including at least one lightfast pigment, according to the disclosure provides for an improvement and of the lightfastness grade of the at least one profile surface forming the exterior surface of the extrusion profile being made of the recycling polymer material to at least a lightfastness grade 4, preferably 5, more preferred 6, even more preferred 7, and most preferred the lightfastness grade 8, of the bluescale, or a lightfastness grade 2, preferably 3, most preferred the lightfastness grade 4, of the greyscale.

For a determination of the change of color according to the grayscale according to DIN EN 20105-A02, a division of the lightfastness into for steps occurs:

lightfastness 4: highest lightfastness

lightfastness 3: very good lightfastness

lightfastness 2: sufficient lightfastness

lightfastness 1: poor lightfastness

Hereby, the lightfastness grade 3 according to the grayscale approximately equals the lightfastness grade 6 of the above-mentioned blue scale.

Preferably, the lightfastness of the profile surface is determined by an illumination process depending upon the illumination power. For example, the lightfastness of the profile surface can be determined according to an illumination process according to DIN 513:1999-10, in which the color temperature is for example determined or accumulated illumination power of approximately 12JG/m² (S-climate) in the wavelength spectrum of 300 nm to 800 nm.

The demands to extrusion profiles according to the disclosure is that step 2, better yet step 3, of the grayscale according to DIN EN 20105-A02 is not undershot. When falling below step 2, or step 3, of the grayscale according to DIN EN 20105-A02, the material may be prone to the formation of stains, blisters, stripes and/or cracks or other noticeable impairments. In an exemplary embodiment, the profile surfaces of the extrusion profile according to the disclosure have a lightfastness of the maximal discoloration ΔE of ≤3.8 Cielab, or of at least step 2, preferably step 3, of the grayscale according to DIN EN 20105-A02.

The lightfastness depends on regional influences. While Germany has an average of 900 kWh/m²-1200 kWh/m² sunray illumination per year, Florida has 1800 kWh/m²-1900 kWh/m² and Arizona even 2200 kWh/m²-2300 kWh/m² per year. Thus, the demands to extrusion profiles according to the disclosure may be different dependent upon the region of application. A lightfastness of 7 in central Europe corresponds to one year in the open without any change of the material.

### Example 5: Determination of the Weather Fastness and Weather-Resiliency

Contrary to the lightfastness, the term “weather fastness” in the sense of this application refers to the fastness of the material against weathering comprising for example UV-illumination, oxygen, air pollution and water.

Such weathering influences may lead to oxidation processes of materials such as polymers which influence not only the visual appearance but also mechanical and physical properties of the material, in particular of the polymer material. For example, crack formation, migration, discoloration and/or changes of the mechanical properties of the material, in particular of the polymer material, can occur.

The determination of the weather fastness and weather resiliency may occur by means of an artificial weathering, for example according to the following process DIN EN 513: 1999-10, simulation of a hot climate zone (s)), during which the exterior surfaces of an object are irradiated as follows:

Parameters of the irradiation device

Device type: XENOTEST(R) BETA LM

Radiation source: Xenon arc irradiation

Filter system: Simulation sunlight in the open

Black stand temperature: 65±3° C.

Weill stand temperature: 45-50° C.

Rel. humidity 65±5%

Cycle: 6 min raining, 114 min dry period

Irradiation strength (300-400) nm: 60±2 W/m2

Accumulated irradiation dosis equivalent

in the wavelength spectrum (300-800) nm: 12 GJ/m2

Time of irradiation: 6121 h

Start: 2014-03-17

End: 2014-12-10

The colorimetric evaluation of the materials, in particular of the surface materials, is preferably performed with the spectral photometer in a wave length area of 360 to 750 nm, for a normal light type D65, a gloss inclusion, and 10° normal observer. The color distance ΔE is determined according to DIN EN ISO 1 1664-4:2012-06.

The features disclosed in the preceding description, the figures and the claims may be of relevance individually as well as in any arbitrary combination thereof for realizing the disclosure in the different embodiments.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

1 extrusion profile
3 profile surface forming extrusion profile exterior side
3 exterior profile web
4 profile basis
5 sealing web
6 seal reception
7 glazing web
9 interior profile web
11 bottom web
13 reinforcement web
15 reinforcement grove
17 extrusion assembly
19 introduction area
21 material funnel
23 dosing device
25 dosing device
26 flow direction of polymer melt
27 flange for mounting the tool (nozzle) to the extruder
28 extrusion tool (nozzle)

1. An extrusion profile for a window component and/or a door component, the extrusion profile comprising:
at least one profile surface forming an exterior side of the extrusion profile, the extrusion profile being made at least of a recycling polymer material and provided with at least one pigmentation including at least one lightfast pigment.

2. The extrusion profile according to claim 1, wherein the recycling polymer material is a compound comprising used-window-granules comprising a mass fraction between 80 wt % and 98 wt % of the compound.

3. The extrusion profile according to claim 1, wherein the recycling polymer material is a compound comprising used-window-granules comprising a mass fraction of 95 wt % of the compound.

4. The extrusion profile according to claim 1, wherein the at least one pigmentation comprises at least one organic and/or at least one inorganic pigment.

5. The extrusion profile according to claim 4, wherein the at least one organic pigment comprises between 0.01 wt % and 10.00 wt % of the compound.

6. The extrusion profile according to claim 4, wherein the at least one organic pigment is selected from a group consisting of: an azo-pigment, a phthalocyanine-pigment, a quinacridone-pigment, a varnish-pigment and carbon black.

7. The extrusion profile according to claim 4, wherein the at least one inorganic pigment comprises a mass fraction between 10 wt % and 50 wt % of the compound.

8. The extrusion profile according to claim 4, wherein the at least one inorganic pigment is selected from a group consisting of: an iron oxide, an iron hydroxide, a zinc ferrite, a zinc oxide, a magnesium ferrite, a manganese ferrite, a cadmium sulfide, chromium(III)-oxide, chromium(III)-oxide-hydrate, chrome oxide green (PG17), chrome oxide hydrate green (PG18), cobalt zincate (CoZn02), malachite (Cu2Co3(OH)2), copper(II)arsenide (CuHAsO3), arsenic(III) sulfide (As2S3), vanadium yellow (PY184), bismuth vanadate (BiVO4), and cadmium yellow (PY37).

9. The extrusion profile according to claim 1, wherein the compound further comprises at least one substance selected from the group consisting of:
(i) a mineral filler component including calcium carbonate, talcum, mica, wollastonite, silica, kaolin, magnesium silicate, aluminium magnesium silicate, potassium aluminium silicate, MicaCelia, graphite, slate, glass fiber, or dolomite;
(ii) a mineral pigment including titanium(IV)oxide (TiO2), zirconium(II)oxide (ZrO), cerium(III)oxide, cadmium sulfide (CdS), calcium ascorbate (CaAs),
zirconium(IV)oxide (ZrO2), iron(I)oxide (Fe2O), iron(II)oxide (Fe2O3), or silicone dioxide (SiO2);
(iii) a polyesterizing agent polymer composition;
(iv) a copolymer including a copolymer of ethylene and vinyl acetate (EVA);
(v) a lubricant including glycerine, a fatty acid, an amino acid, a paraffin oil, a paraffin, polyethylene, a fatty acid amide, or a silicone oil;
(vi) a polyvinyl chloride including K65-polyvinyl chloride, K66-polyvinyl chloride, K67-polyvinyl chloride, K68-polyvinyl chloride, or K69-polyvinyl chloride; and
(vii) an ester including a phthalic acid ester (phthalate), diallyl phthalate, di-2-ethylhexyle phthalate, di-isooctyl phthalate, or tetrabrom dioctyl phthalate.

10. The extrusion profile according to claim 1, wherein the compound comprises: an organic pigment, an inorganic pigment, and a mineral pigment.

11. The extrusion profile according to claim 10, wherein the mineral pigment is titanium(IV)oxide (TiO2).

12. The extrusion profile according to claim 10, wherein the compound further comprises a mineral filler component, a polyesterizing agent polymer composition, a polyvinyl chloride, and/or an ester.

13. The extrusion profile according to claim 12, wherein the ester is a phthalic acid ester (phthalate).

14. The extrusion profile according to claim 10, wherein the organic pigment comprises a mass fraction between 0.5 wt % and 1.5 wt %, the inorganic pigment comprises a mass fraction between 25.0 wt % and 35.0 wt %, the mineral pigment, in particular titanium(IV)oxide (TiO2), a mass fraction between 20.0 wt % and 30 wt %, the mineral filler component comprises a mass fraction between 0.0 wt % and 35.0 wt % of the compound, the polyesterizing agent polymer composition comprises a mass fraction between 0.0 wt % and 45 wt %, the polyvinyl chloride comprises a mass fraction between 0.0 wt % and 35 wt %, and the ester comprises a mass fraction between 0.0 wt % and 30 wt % of the compound.

15. The extrusion profile according to claim 1, wherein the at least on pigmentation including the at least one lightfast pigment increases a lightfastness of the at least one profile surface to a lightfastness grade 8 on a blue scale, or a lightfastness grade 4 on a grey scale.

16. A method for manufacturing an extrusion profile comprising:
providing an extrusion material; and
extruding the extrusion material to form at least one profile surface forming an exterior surface of the extrusion profile, wherein the extrusion profile is made of at least a recycled polymer material and includes at least one pigmentation having at least one lightfast pigment.

17. The method according to claim 16, wherein the at least one pigmentation having the at least one lightfast pigment increases a lightfastness of the at least one profile surface to at least a lightfastness grade 8 on a blue scale, or a lightfastness grade 4 on a grey scale.

18. The method according to claim 17, wherein the lightfastness of the at least one profile surface is determined by:
(i) illuminating a grading sample and a first component of the profile surface, wherein a second part of the profile surface is covered,
(ii) comparing the first component of the profile surface with the second part of the profile surface and the grading sample, and
(iii) determining the lightfastness based on the grading of the sample.
